(19) United States
(12) Patent Application Publication
(10) Pub. No.: US 2005/0213804 A1
(43) Pub. Date: Sep. 29, 2005

(54) System and method of displaying images of a deposited envelope

(75) Inventor: David Gregg Simmons, Waterloo (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 10/809,661

(22) Filed: Mar. 25, 2004

(51) Int. Cl. G06K 9/00

(52) U.S. Cl. 382/137

(57) ABSTRACT

An automated teller machine (ATM) receives an envelope from an ATM customer conducting an ATM transaction, and prints a transaction number on the envelope received from the ATM customer. An image capture workstation captures a front image of the envelope and a rear image of the envelope. A keying and balancing workstation includes a display and a processor which processes the front and rear images of the envelope to present a superimposed image of at least a portion of the front image and at least a portion of the rear image on the display. The processor may also process the superimposed image to present a rotated image of the superimposed image on the display such that the superimposed image and the rotated image of the superimposed image are presented adjacent to each other on the display.

### BACKGROUND OF THE INVENTION

The present invention relates to envelopes deposited at a self-service terminal, such as an automated teller machine (ATM), which is capable of receiving an envelope, and is particularly directed to a system and a method of displaying images of a deposited envelope.

An ATM which is capable of receiving an envelope allows a user to deposit an envelope containing items, such as cash, checks, deposit slips, and the like, in a public access, unattended environment. To deposit such an envelope, a user inserts a user identification card through a user card slot at the ATM, enters an amount being deposited, and inserts the envelope to be deposited through an envelope deposit slot. A transport mechanism receives the envelope and transports the envelope along a transport path to a number of locations within the ATM to process the envelope. If the envelope is not accepted for deposit, the envelope is returned to the user. If the envelope is accepted for deposit, a printer prints a transaction number onto the envelope and then the envelope is transported to and deposited in a storage bin within the ATM.

Deposited envelopes in the storage bin within the ATM are periodically picked up and transported to a branch office facility. At the branch office facility, the deposited envelopes are opened, and their content items are examined and processed in a known manner. Each envelope and its associated content items (except cash) are kept together. When cash is found in an envelope, the cash is taken out and a cash slip is made out as an item and kept together with the associated envelope. The envelopes along with their content items are then transported to a centralized back office facility of a financial institution. At the centralized back office facility, the envelopes along with their content items such as cash slips, checks, deposit slips, and the like are prepared at a document preparation and tray building workstation for subsequent processing at a number of different processing workstations located at the centralized back office facility.

In a first pass of items including the envelopes through an image capture workstation, image data which is representative of images of items including the envelopes is captured.

Then in a second pass of items through an encoding and sorting workstation, the items are encoded and sorted and matched up with their corresponding image data which was previously captured during the first pass. Items other than the envelopes are processed for purpose of clearing checks between financial institutions, as is known.

After the first pass of items through the image capture workstation, an image of each envelope is presented on a display screen of a display terminal at a keying and balancing workstation to allow a human operator at the workstation to view the image of the envelope. More specifically, the image of an envelope is presented on the display screen of the display terminal so that the operator can read the transaction number from the image and key in the transaction number. The transaction number from the image of the envelope is keyed in to allow the particular envelope (and its associated content items) to be quickly identified during balancing of items at the keying and balancing workstation, as is known.

Sometimes the image of the envelope presented on the display screen of the display terminal at the keying and balancing workstation is not properly oriented so as to allow the operator to read the transaction number from the image. For example, the front image of the envelope may be presented on the display screen of the display terminal, but the transaction number is actually contained in the rear image of the envelope. In this case, the operator would need to press a “FLIP” key, as is known, so that the rear image of the envelope is presented on the display screen of the display terminal in place of the front image of the envelope. As another example, if an image of the envelope presented on the display screen of the display terminal is upside down, the operator would need to press a “ROTATE” key, as is known, so that a right-side up image of the envelope is presented on the display screen of the display terminal in place of the upside down image of the envelope.

While use of the “FLIP” key and use of the “ROTATE” key allow the operator to correct orientation of images of envelopes presented on the display screen of the display terminal so that the operator can read a transaction number, it does take time for the operator to press these keys. It would be desirable to eliminate, or at least minimize usage of these keys while the operator is attempting to read a transaction number from an image of an envelope.

### SUMMARY OF THE INVENTION

In accordance with one aspect of the present invention, a system comprises an automated teller machine (ATM) including (i) means for receiving an envelope from an ATM customer conducting an ATM transaction, and (ii) means for printing a transaction number on the envelope received from the ATM customer. The system further comprises an image capture workstation for capturing a front image of the envelope and a rear image of the envelope. The system also comprises a keying and balancing workstation including (i) a display, and (ii) a processor including means for processing the front and rear images of the envelope to present a superimposed image of at least a portion of the front image and at least a portion of the rear image on the display. The processor may also include means for processing the superimposed image to present a rotated image of the superimposed image on the display such that the superimposed image and the rotated image of the superimposed image are presented adjacent to each other on the display.

In accordance with yet another aspect of the present invention, a method of displaying front and rear images of an envelope which has been deposited at a self-service deposit terminal comprises displaying the front and rear images of the deposited envelope such that at least a portion of the front image of the deposited envelope and at least a portion of the rear image of the deposited envelope superimpose.

In accordance with still another aspect of the present invention, a method comprises printing a transaction number on an envelope deposited at a self-service terminal, capturing an image of one side of the deposited envelope, capturing an image of an opposite side of the deposited envelope, and superimposing the images of the deposited envelope on a display to allow an operator to read the transaction number from the images independent of which side the transaction number was printed on the envelope.

In accordance with yet another aspect of the present invention, a method of a human operator keying in a transaction number associated with an envelope which has been deposited at an automated teller machine (ATM) comprises reading a transaction number from superimposed front and rear images of the deposited envelope on a display, wherein the transaction number appears in only one of the images, and keying in the transaction number which appears in the one image.

In accordance with another aspect of the present invention, an apparatus is provided for enabling a human operator to read a transaction number from first and second images of an envelope which has been deposited at a self-service terminal. The apparatus comprises a display, and means for displaying the first and second images on the display so that at least a portion of the first image and at least a portion of the second image superimpose.

### BRIEF DESCRIPTION OF THE DRAWINGS

These and other aspects of the present invention will be apparent from the following specific description, given by way of example, with reference to the accompanying drawings, in which:

FIG. 1 is a pictorial diagram of an automated teller machine (ATM) which is capable of receiving an envelope;

FIG. 2 is a simplified schematic sectional diagram, taken approximately along line 2-2 in FIG. 1, and showing a portion of the ATM of FIG. 1;

FIG. 3 is a diagram of a front side of an envelope which can be deposited at the ATM of FIG. 1;

FIG. 4 is a diagram of a rear side of the envelope of FIG. 3;

FIG. 5 is a diagram similar to FIGS. 3 and 4 and showing a transaction number printed on the front side of the envelope of FIGS. 3 and 4;

FIG. 6 is a schematic block representation of an image-based check processing system for capturing images of the envelope of FIG. 5;

FIG. 7 is a schematic block representation of an image capture workstation in the image-based check processing system of FIG. 6;

FIG. 8 is an enlarged schematic block representation of a portion of the image-based check processing system of FIG. 6;

FIG. 9 is a diagram of a displayed image of the front side of the envelope shown in FIG. 5;

FIG. 10 is a diagram of a displayed image of the rear side of the envelope shown in FIG. 5;

FIG. 11 is a diagram of a displayed superimposed image of the front and rear images shown in FIGS. 9 and 10;

FIG. 12 is a diagram similar to FIG. 5 and showing a transaction number printed on the rear side of the envelope of FIGS. 3 and 4;

FIG. 13 is a diagram of a displayed image of the front side of the envelope shown in FIG. 12;

FIG. 14 is a diagram of a displayed image of the rear side of the envelope shown in FIG. 12;

FIG. 15 is a diagram of a displayed superimposed image of the front and rear images shown in FIGS. 13 and 14; and

FIG. 16 is a diagram similar to FIG. 15 and showing additionally a displayed rotated image of the superimposed image of FIG. 15.

### DETAILS OF THE INVENTION

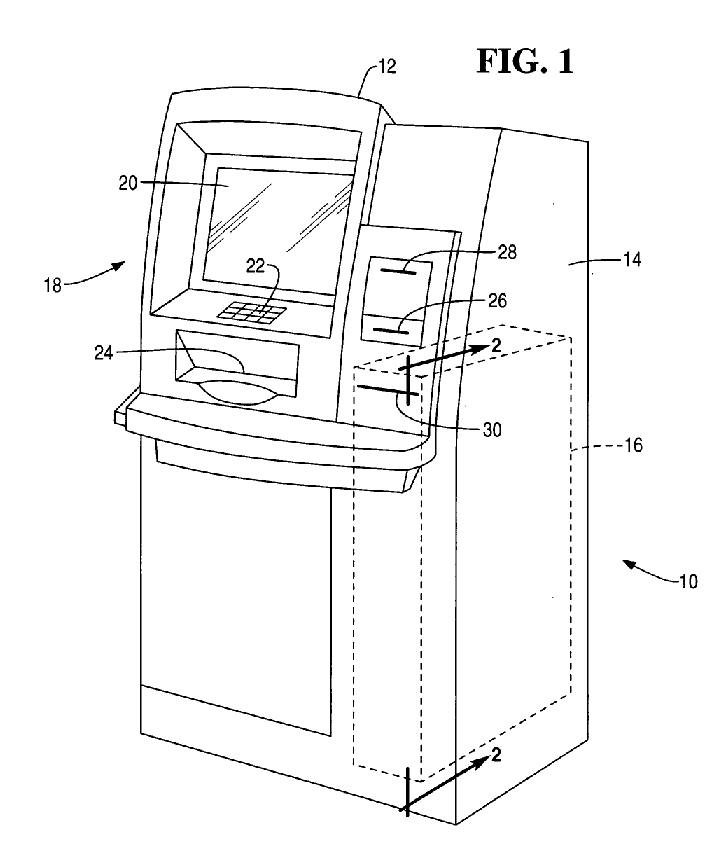

The present invention is directed to a system and a method of displaying images of a deposited envelope. The envelope has been deposited at a self-service terminal, such as an automated teller machine (ATM) 10 shown in FIG. 1, which is capable of receiving envelopes.

The ATM 10 shown in FIG. 1 includes a chassis (not shown) for supporting a fascia 12, exterior panels 14, and an internal envelope depositing module (EDM) 16. The ATM 10 further includes a display 20, a keypad 22, a cash dispense slot 24, a card entry/exit slot 26, a receipt slot 28, and an envelope depositing slot 30. When the fascia 12 engages fully with the chassis and panels 14, the slots 24, 26, 28, 30 align with user interface elements located within the ATM 10.

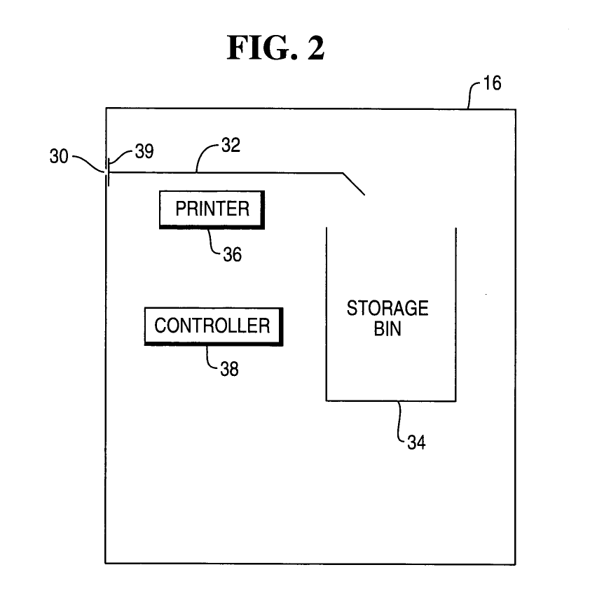

The EDM 16 will now be described with reference to FIG. 2 which is a simplified schematic sectional diagram (along line 2-2 in FIG. 1) showing part of the fascia 12 and the main parts of the EDM 16. The EDM 16 includes an envelope transport mechanism 32 which extends between the envelope depositing slot 30 and an envelope storage bin 34 for storing deposited envelopes. The EDM 16 further includes a printer 36 for printing a transaction number onto an envelope as the envelope is transported past the printer. The EDM 16 also includes a controller 38 for controlling the operation of the elements within the EDM. The EDM 16 also includes an entrance shutter 39 for opening and closing the envelope deposit slot 30. The structure and operation of the EDM 16 are conventional and, therefore, will not be further described.

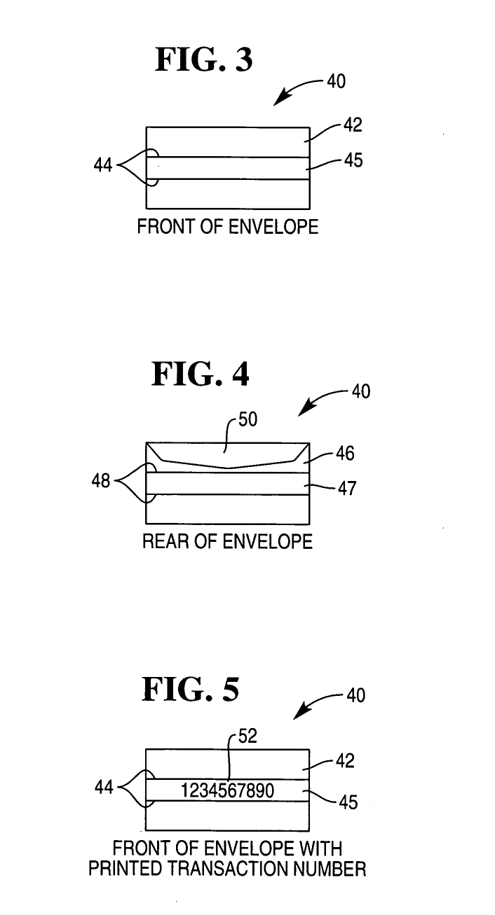

A typical envelope 40 for depositing in the ATM 10 is shown in FIGS. 3 and 4. FIG. 3 illustrates a front side 42 of the envelope 40, and FIG. 4 illustrates a rear side 46 of the envelope. The front side 42 of the envelope 40 has a pair of lengthwise-extending bands 44 which define a printing area 45 on which a transaction number can be printed. The printing area 45 is equidistant from the top and bottom edges of the envelope 40. Similarly, the rear side 46 of the envelope 40 has a pair of lengthwise-extending bands 48 which define a printing area 47 on which a transaction number can be printed. The printing area 47 is also equidistant from the top and bottom edges of the envelope 40.

When an envelope, like the envelope 40 shown in FIGS. 3 and 4, is deposited at the ATM 10, a transaction number can be printed on either the printing area 45 on the front side 42 of the envelope or the printing area 47 on the rear side 46 of the envelope. As an example, as shown in FIG. 5, a transaction number designated by reference numeral 52 is printed on the printing area 45 on the front side 45 of the envelope 40 of FIGS. 2 and 4. As shown in FIG. 5, the transaction number 52 printed on the printing area 45 is “1234567890”.

A courier picks up deposited envelopes from the envelope storage bin 34 in the ATM 10. The envelopes picked up from the envelope storage bin 34 are transported to a branch office facility of a financial institution for subsequent processing. More specifically, at the branch office facility, the deposited envelopes are opened, and their content items are examined and processed in a known manner. Each envelope and its associated content items (except cash) are kept together. When cash is found in an envelope, the cash is taken out and a cash slip is made out as an item and kept together with its associated envelope. The envelopes along with their content items are then transported to a centralized back office facility of the financial institution for further processing.

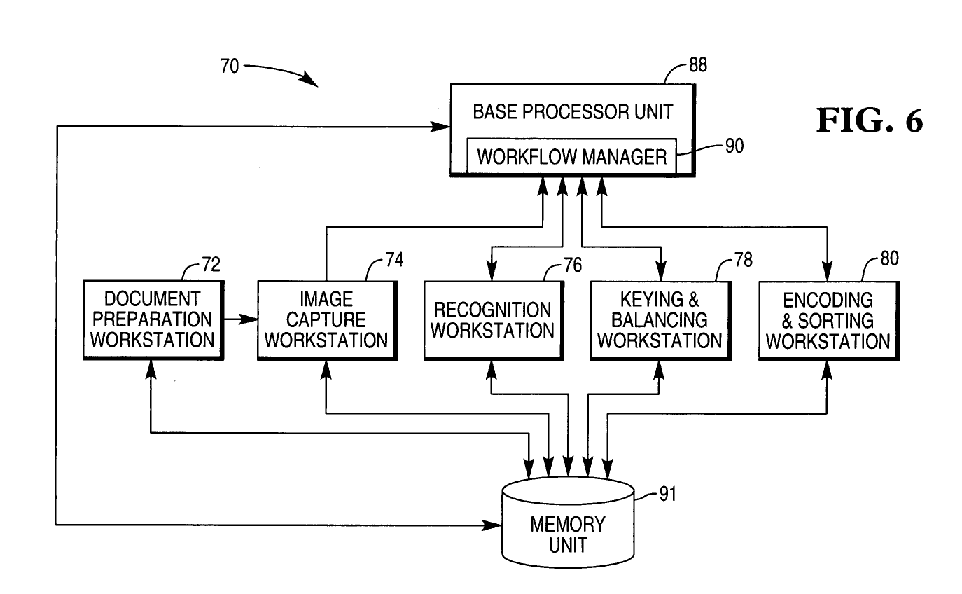

As shown in FIG. 6, the centralized back office facility has an image-based check processing system 70 at which the envelopes along with their content items are processed. The image-based check processing system 70 comprises different types of workstations including a document preparation workstation 72, an image capture workstation 74, a recognition workstation 76, a keying and balancing workstation 78, and an encoding and sorting workstation 80. At the document preparation workstation 72, transaction items including a number of debit items and a number of credit items associated with each transaction are prepared for further processing downstream from the document preparation workstation 72. Typical transaction items include checks, cash slips, and envelopes. Accordingly, when the envelopes with their content items arrive at the centralized back office facility, they are received at a document preparation and tray building workstation 72 and are built into document trays in a known manner.

More specifically, items contained in each envelope are removed from the envelope and prepared for further processing. The items are prepared for further processing by properly orienting the items and by removing paper clips, staples, and the like. The prepared items along with their envelope are stacked and placed into a document tray behind a tray header document, as is known. The document trays containing the stacked items are then manually carted to the image capture workstation 74 to process the items in a first pass through the image capture workstation 74.

The image capture workstation 74 creates units of work and submits the created work to a workflow manager 90 in a known way. As shown in FIG. 6, the workflow manager 90 resides in non-volatile memory in a base processor unit 88 of the image-based check processing system 70. Each of the workstations 76, 78, 80, 82 polls the workflow manager 90 in a known manner for work to perform, and may also create units of work which is submitted back to the workflow manager 90.

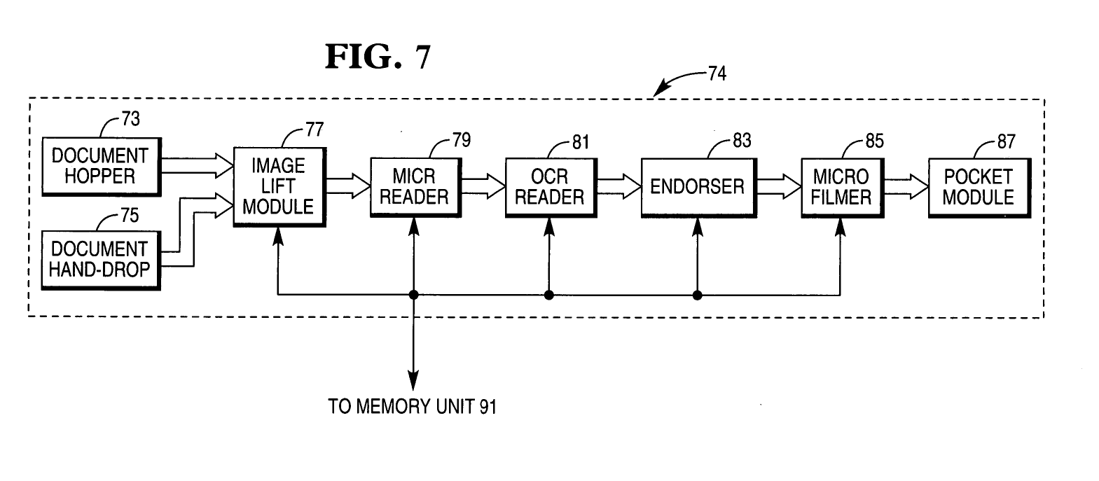

Referring to FIG. 7, the image capture workstation 74 includes a document hopper 73 into which stacked items from the document trays can be placed so that the items can be transported along a document feed path of the image capture workstation 74. The image capture workstation 74 also includes a document hand-drop 75 into which single items can be manually placed by a human operator so that the item can be merged into and then transported along the document feed path. The image capture workstation 74 further includes a number of different devices which lie along the document feed path. More specifically, as shown in FIG. 7, the image capture workstation 74 includes an image lift module 77, a MICR reader 79, an OCR reader 81, an endorser 83, and a microfilmer 85, all of which lie along the document feed path. A pocket module 87 is disposed at the end of the document feed path. The pocket module 87 has a number of sorter pockets (not shown) for receiving and pocketing items which have been processed along the document feed path by the different devices along the document feed path.

During operation of the image capture workstation 74, the stacked items in the document trays are manually removed from the trays and placed into the document hopper 73. A transport mechanism (not shown) picks items one-by-one from the document hopper 73 and transports the picked items along the document feed path of the image capture workstation 74 in a known manner. Each device lying along the document feed path processes each item transported along the document feed path in a manner described hereinbelow.

If the item moving downstream along the document feed path is an envelope, such as the envelope 40 shown in FIG. 5, a front image lift camera (not shown) of the image lift module 77 lifts an image of the front side 42 of the envelope. More specifically, the front image lift camera optically scans the front side 42 of the envelope 40 as the envelope moves along the document feed path past the front image lift camera to produce a front electronic image of the envelope. The front image of the envelope 40 is stored in a memory unit 91.

Similarly, a rear image lift camera (also not shown) lifts an image of the rear side 44 (FIG. 4) of the envelope 40. The rear image lift camera optically scans the rear side 44 of the envelope 40 as the envelope moves along the document feed path past the rear image lift camera to produce a rear electronic image of the envelope. The rear image of the envelope 40 is also stored in the memory unit 9 1. After the front and rear images of the envelope 40 are captured and stored in the memory unit 91, the envelope is sorted into an appropriate sorter pocket of the pocket module 87. Preferably, the image capture workstation 74 includes the Model iTran 8000 Item Processing System, manufactured by NCR Corporation, located in Dayton, Ohio.

If the item moving downstream along the document feed path is a check, the front and rear images of the check are also captured and stored in the memory unit 91. Additionally, the MICR reader 79 reads a MICR codeline at the bottom of the check as the check passes by the MICR reader 79. Information from the MICR codeline of the check including a unique sequence number is associated with the front image of the check and is also stored in the memory unit 91.

The endorser 83 prints a suitable endorsement onto the check as the check continues to move further downstream along the document feed path past the endorser 83. An endorsement status associated with the check is then stored in the memory unit 91 along with the other information associated with the check. Also, the microfilmer 85 microfilms the check as the check continues to move along the document feed path past the microfilmer 85.

A microfilm status associated with the check is then stored in the memory unit 91 along with the other information associated with the check.

After the front and rear images of the check, the sequence number, and the MICR codeline are stored in the memory unit 91, and the check is endorsed and microfilmed, the check is sorted into an appropriate sorter pocket of the pocket module 87. Other items (cash slip and deposit slips, for examples) are processed in a similar manner. The sorted items in each of the sorter pockets of the pocket module 87 are then stacked in a respective document tray. The document trays containing the stacked items are then manually carted to the encoding and sorting workstation 80 (FIG. 6) to process the items in a second pass through the encoding and sorting workstation 80.

During operation of the encoding and sorting workstation 80, each check is encoded in a known manner. An encoder status associated with each check is also stored in the memory unit 91 along with the other information associated with the check. Preferably, the encoding and sorting workstation 80 also includes the Model iTran 8000 Item Processing System, manufactured by NCR Corporation, located in Dayton, Ohio. The further processing of items at the encoding and sorting workstation 80 is conventional and well known and, therefore, will not be described.

For each check, the front electronic image, the rear electronic image, the sequence number, and the MICR codeline, which were earlier obtained and stored in the memory unit 91 at the image capture workstation 74, are processed further at the recognition workstation 76. At the recognition workstation 76, the front electronic image of each check stored in the memory unit 91 is processed using known recognition techniques to determine the “amount” associated with the check. The amount of the check is then associated with the corresponding front electronic image and the MICR codeline of the check and stored in the memory unit 91.

It should be apparent that a one-to-one correspondence is established between the front electronic image, the sequence number, the MICR codeline, the endorsement status, the encoder status, and the microfilm status of the check and the amount associated with that particular check. Accordingly, a database containing the front electronic image, the sequence number, the MICR codeline, the endorsement status, the encoder status, the microfilm status, and the amount associated with each check is thereby created and stored in the memory unit 91.

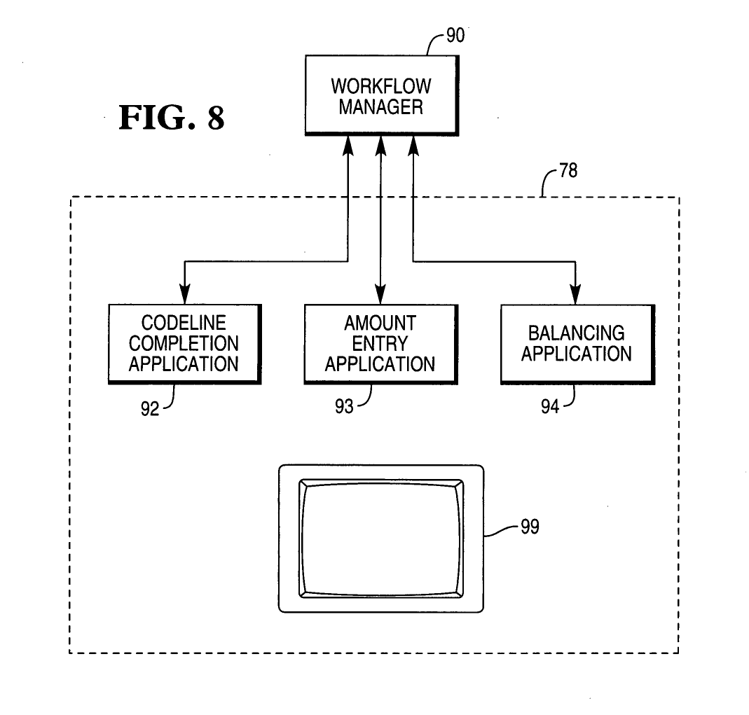

As is known, some amounts will not be recognizable to the recognition workstation 76. Also, some amounts recognized at the recognition workstation 76 may have a low confidence level associated therewith. These items are identified and then processed further at the keying and balancing workstation 78. As shown in FIG. 8, the keying and balancing workstation 78 comprises a number of applications including a codeline completion application 92, an amount entry application 93, and a balancing application 94. Each of the applications 92, 93, 94 communicates with the workflow manager 90 and receives units of work to process from the workflow manager 90 in response to units of work being completed by the recognition workstation 76. An operator at the keying and balancing workstation 78 may select any one of the applications 92, 93, 94 to further process items.

The operator may select the codeline completion application 92 from an application selection menu (not shown) which enables the operator to manually complete the MICR (magnetic ink character recognition) codeline which identifies the particular transaction document item. More specifically, the workflow manager 90 establishes, in a known way, any items with either missing or rejected MICR-related information. These items are displayed on a display screen of a display terminal 99 (FIG. 8) at the keying and balancing workstation 78. The operator at the keying and balancing workstation 78 completes the codelines of the items identified as having either missing or rejected MICR-related information.

An operator at the keying and balancing workstation 78 may also select the amount entry application 93 from the application selection menu which enables the operator to manually complete the amount of the debit items and the credit items, as the case may be. More specifically, after the MICR codelines of all of the items have completed, the workflow manager 90 establishes, in a known way, any items with either missing, rejected, or low confidence amount information from the recognition workstation 76. These items are displayed on the display screen of the display terminal 99 at the keying and balancing workstation 78. The operator at the keying and balancing workstation 78 completes the amount field of the items identified as having missing, rejected, or low confidence amounts.

An operator at the keying and balancing workstation 78 may also select the balancing application 94 from the application selection menu which enables the operator to balance out-of-proof transactions. More specifically, after the amount fields of all of the items have been completed, the workflow manager 90 establishes, in a known way, any batches of items containing transactions which are out-of-proof. The structure and operation of the keying and balancing workstation 78 are well known and, therefore, will not be described in detail.

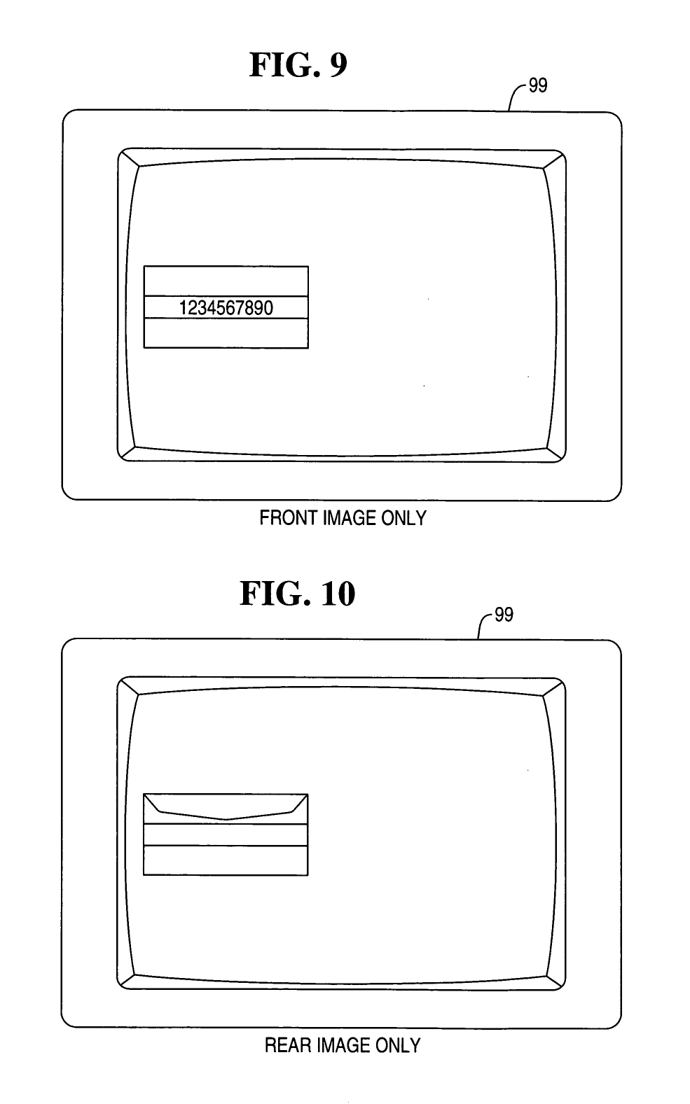

Typically, an envelope being processed is identified by the total amount of its contents. When an envelope cannot be identified from the amount, the associated transaction number needs to be keyed in by a human operator, as is known. To accomplish this, an image of the envelope being processed is presented on the display screen of the display terminal 99 at the keying and balancing workstation 78 so that the operator can view the image of the envelope. From the image of the envelope, the operator reads the transaction number and keys in the transaction number printed on the envelope. The keying in of the transaction number for each envelope allows the particular envelope (and accordingly its associated content items) to be quickly identified during balancing of items at the keying and balancing workstation 78, as is known. As an example, referring to FIG. 9, an image of the front side of the envelope of FIG. 5 is shown displayed on the display screen of the display terminal 99. Similarly, referring to FIG. 10, an image of the rear (back) side of the envelope of FIG. 5 is shown displayed on the display screen of the display terminal 99.

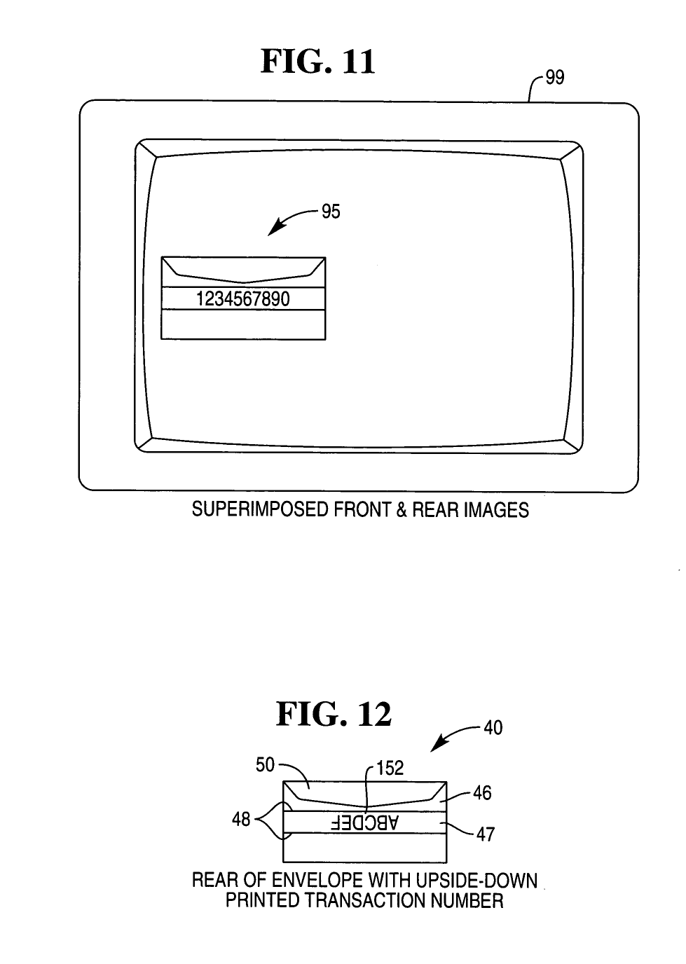

In accordance with the present invention, as shown in FIG. 11, a superimposed image 95 of the image of the front side of the envelope shown in FIG. 9 and the image of the rear side of the envelope shown in FIG. 10 is displayed on the display screen of the display terminal 99. When the image of the front side of the envelope shown in FIG. 9 and the image of the rear side of the envelope shown in FIG. 10 are superimposed as shown in FIG. 1 1, the printing area 45 on the front side 42 of the envelope 40 coincides with the printing area 47 on the rear side 46 of the envelope. By displaying the superimposed image 95 on the display screen of the display terminal 99, as shown in FIG. 11, the operator can read a transaction number from the superimposed image without having to press a “FLIP” key to reorient any image presented on the display screen of the display terminal. Operation of the “FLIP” key by an operator at the keying and balancing workstation 78 to reorient an image presented on the display screen of the display terminal 99 at the keying and balancing workstation is well known and, therefore, will not be described. By eliminating the need of the operator to press the “FLIP” key when the operator is attempting to read a transaction number from an image of an envelope displayed on the display screen of the display terminal 99 at the keying and balancing workstation 78, a relatively high operating efficiency of the keying and balancing workstation results.

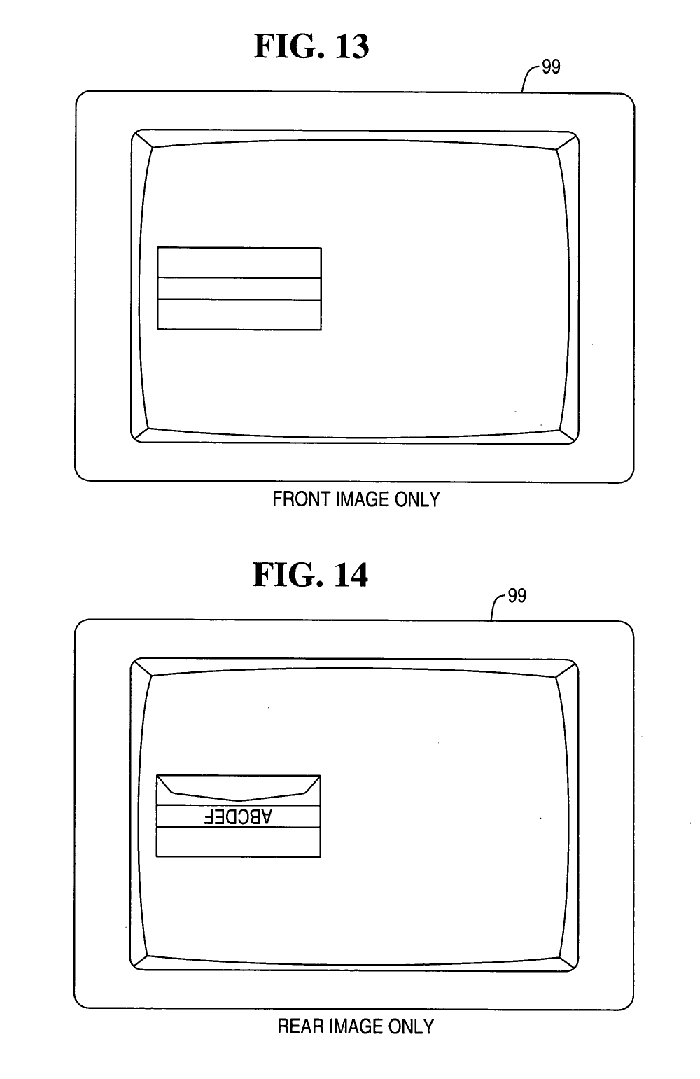

As another example, referring to FIG. 12, the envelope 40 of FIG. 5 has a transaction number designated by reference numeral 152 (FIG. 12) printed on the printing area 47 on the rear side 46 of the envelope. It should be noted that the transaction number 152 printed on the printing area 47 on the rear side 46 of the envelope 40 shown in FIG. 12 is printed upside down. As shown in FIG. 12, the transaction number 152 printed on the printing area 47 is an upside down “ABCDEF”. Referring to FIG. 13, an image of the front side of the envelope of FIG. 12 is shown displayed on the display screen of the display terminal 99. Similarly, referring to FIG. 14, an image of the rear side of the envelope of FIG. 12 is shown displayed on the display screen of the display terminal 99.

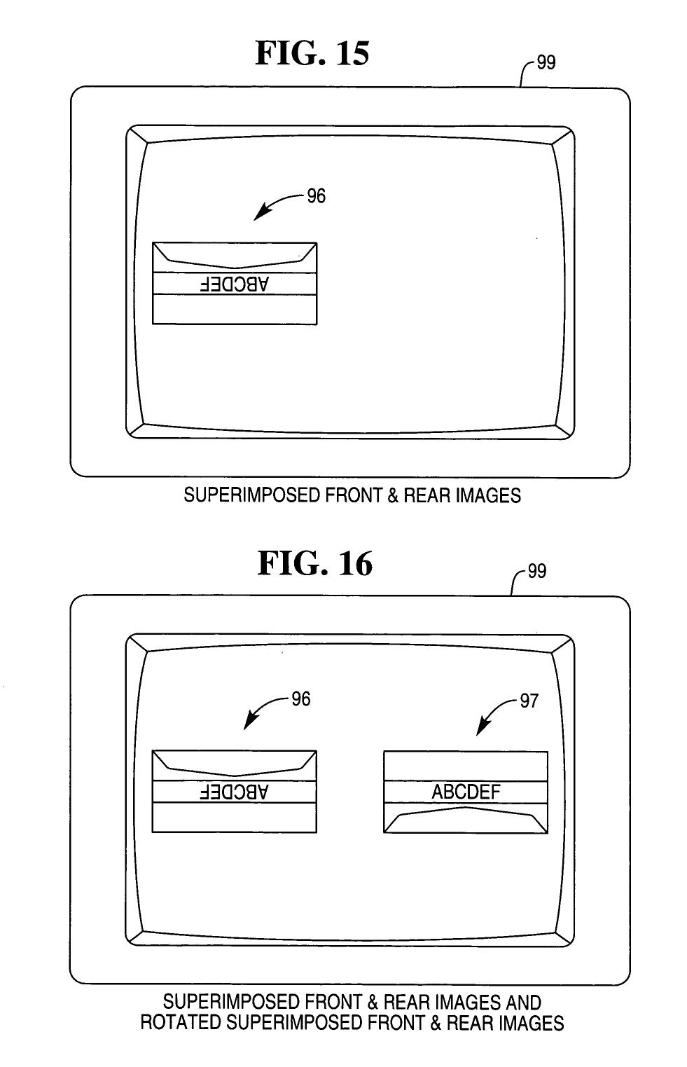

In accordance with the present invention, as shown in FIG. 15, a superimposed image 96 of the image of the front side of the envelope shown in FIG. 13 and the image of the rear side of the envelope shown in FIG. 14 is displayed on the display screen of the display terminal 99. When the image of the front side of the envelope shown in FIG. 13 and the image of the rear side of the envelope shown in FIG. 10 are superimposed as shown in FIG. 15, the printing area 45 on the front side 42 of the envelope 40 coincides with the printing area 47 on the rear side 46 of the envelope. Additionally, as shown in FIG. 16, a rotated image 97 of the superimposed image 96 is displayed on the display screen of the display terminal 99. Although the superimposed image 96 and the rotated image 97 of the superimposed image are shown in FIG. 16 as being adjacent to each other on the display screen of the display terminal 99, it is conceivable that the images may be displayed relative to each other anywhere on the display screen of the display terminal 99.

By displaying the superimposed image 96 and the rotated image 97 of the superimposed image on the display screen of the display terminal 99, as shown in FIG. 16, the operator can read a transaction number from either the superimposed image or the rotated image of the superimposed image without having to press either the “FLIP” key or a “ROTATE” key to reorient any image presented on the display screen of the display terminal 99. Operation of the “FLIP” key and operation of the “ROTATE” key by an operator at the keying and balancing workstation 78 to reorient an image presented on the display screen of the display terminal 99 are well known and, therefore, will not be described. By eliminating the need of the operator to press either the “FLIP” key or the “ROTATE” key when the operator is attempting to read a transaction number from an image of an envelope displayed on the display terminal 99 at the keying and balancing workstation 78, again a relatively high operating efficiency of the keying and balancing workstation results.

Although the above description with reference to FIG. 16 describes displaying the superimposed image 96 and the rotated image 97 of the superimposed image on the display screen of the display terminal 99, it is conceivable that only one of these images be presented on the display screen of the display terminal 99 and that the other one of these images be obtained by the operator pressing the “ROTATE” key.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

1. A system comprising:
an automated teller machine (ATM) including (i) means for receiving an envelope from an ATM customer conducting an ATM transaction, and (ii) means for printing a transaction number on the envelope received from the ATM customer;
an image capture workstation for capturing a front image of the envelope and a rear image of the envelope; and
a keying and balancing workstation including (i) a display, and (ii) a processor including means for processing the front and rear images of the envelope to present a superimposed image of at least a portion of the front image and at least a portion of the rear image on the display.

2. A system according to claim 1, wherein the processor includes means for processing the superimposed image to present a rotated image of the superimposed image on the display such that the superimposed image and the rotated image of the superimposed image are presented adjacent to each other on the display.

3. A method of displaying front and rear images of an envelope which has been deposited at a self-service deposit terminal, the method comprising:
displaying the front and rear images of the deposited envelope such that at least a portion of the front image of the deposited envelope and at least a portion of the rear image of the deposited envelope superimpose.

4. A method comprising:
printing a transaction number on an envelope deposited at a self-service terminal;
capturing an image of one side of the deposited envelope;
capturing an image of an opposite side of the deposited envelope; and
superimposing the images of the deposited envelope on a display to allow an operator to read the transaction number from the images independent of which side the transaction number was printed on the envelope.

5. A method of a human operator keying in a transaction number associated with an envelope which has been deposited at an automated teller machine (ATM), the method comprising:
reading a transaction number from superimposed front and rear images of the deposited envelope on a display, wherein the transaction number appears in only one of the images; and
keying in the transaction number which appears in the one image.

6. An apparatus for enabling a human operator to read a transaction number from first and second images of an envelope which has been deposited at a self-service terminal, the apparatus comprising:
a display; and
means for displaying the first and second images on the display so that at least a portion of the first image and at least a portion of the second image superimpose.
